(19) United States
(12) Patent Application Publication
(10) Pub. No.: US 2025/0378807 A1
(43) Pub. Date: Dec. 11, 2025

(54) MODULAR STRINGLESS GUITAR

(71) Applicant: HUIZHOU ENYA MUSICAL INSTRUMENT CO., LTD., HUIZHOU (CN)

(72) Inventor: HAIMING HU, HUIZHOU (CN)

(21) Appl. No.: 19/266,470

(22) Filed: Jul. 11, 2025

Related U.S. Application Data
(63) Continuation of application No. PCT/CN2024/123992, filed on Oct. 10, 2024.

(30) Foreign Application Priority Data
Jun. 6, 2024 (CN) 202421294061.9
Jun. 6, 2024 (CN) 202421297741.6
Jun. 6, 2024 (CN) 202421299744.3
Jun. 25, 2024 (CN) 202421467321.8

(51) Int. Cl. G10H 1/34; G10H 1/00

(52) U.S. Cl. CPC G10H 1/342; G10H 1/0008; G10H 2220/036; G10H 2220/056; G10H 2220/221

(57) ABSTRACT

A modular stringless guitar includes a keyboard, a speaker, a guitar body, a chord board, a guitar neck, a tuning device, and a light indication system. The guitar body is a box structure. The keyboard and the speaker are disposed in the guitar body. A plug-in portion disposed on the guitar neck is movably connected to an interface of the guitar body. The tuning device is disposed on the guitar neck. The tuning device includes a rocker and a sensor. A first end of the rocker is connected to the sensor. A second end of the rocker extends out of a side surface of the guitar neck. The light indication system includes a first indicator light and a second indicator light. The first indicator light indicates playing positions on the keyboard. The second indicator light indicates playing positions on the chord board.

### TECHNICAL FIELD

The present disclosure relates to a technical field of musical instruments, and in particular to a modular stringless guitar.

### BACKGROUND

A stringless guitar is an innovative form of an innovative electronic musical instrument that omits physical strings required by a classical guitar and instead uses advanced sensing technology and electronic devices to simulate or generate musical sounds. The stringless guitar not only retains an appearance and some operating methods of the classic guitar, but also integrates touch sensors or other electronic sensors to accurately detect positions and movements of fingers of a player. The innovative features of the stringless guitar allow the player to trigger different notes through finger operations like playing the classic guitar, while further allowing the player to create rich sound effects and musical styles by the stringless guitar. However, the stringless guitar in the prior art still has certain limitations in terms of portability, playing stability, versatility, and convenience of tone adjustment.

First, since the stringless guitar in the prior art commonly adopts an integrated design, a neck and a body thereof are unable to be disassembled, which makes the stringless guitar bulky and inconvenient to carry and store. Secondly, the stringless guitar has simple playing methods. It is not convenient to adjust the tone and timbre during the performance, and the stringless guitar is unable to adapt to different music styles and occasions, thus limiting the freedom of performance. Finally, a tuning device of the stringless guitar is commonly disposed on the body, which is easy to affect the performance due to accidental contact. Further, it is not convenient to make quick adjustments on the tuning device during the performance.

In view of problems in the prior art, how to design a stringless guitar that is convenient to carry, has various playing methods, and is easy to adjust the tone and timbre during the performance has become an important issue in a field of musical instrument manufacturing. In response to the problems in the prior art, the present disclosure proposes a modular stringless guitar, which aims to solve shortcomings of the stringless guitar in the prior art in terms of portability and functionality, so as to enhance a playing experience and creative freedom of the player.

### SUMMARY

To solve problems in the prior art, the present disclosure proposes a modular stringless guitar, which aims to solve shortcomings of a stringless guitar in the prior art in terms of portability and functionality, so as to enhance a playing experience and creative freedom of the player.

The present disclosure provides the modular stringless guitar. The modular stringless guitar comprises a keyboard, a speaker, a guitar body, a chord board, a guitar neck, a tuning device, and a light indication system.

The guitar body is a box structure having electronic components disposed therein. The keyboard is disposed in a first mounting space of the guitar body. The speaker is mounted in a second mounting space of the guitar body. A plug-in portion disposed on a first end of the guitar neck is movably connected to an interface of the guitar body. The tuning device is disposed at a second end of the guitar neck. The tuning device comprises a rocker and a sensor. A first end of the rocker is connected to the sensor. A second end of the rocker extends out of a side surface of the guitar neck. The rocker is configured for a player to operate. The light indication system comprises a first indicator light and a second indicator light. The first indicator light is configured to indicate playing positions on the keyboard. The second indicator light is configured to indicate playing positions on the chord board.

Furthermore, the plug-in portion comprises a plugging block, a fastener, and an elastic piece.

The plugging block is integrally connected to the guitar neck. The fastener is hinged to the guitar neck. The elastic piece is disposed between the fastener and the plugging block. A first end of the fastener is hinged in a pressing hole of the guitar neck. A middle portion of the fastener defines a pressing groove. A protruding block is disposed on a second end of the fastener. The protruding block is engaged with a groove defined in the interface.

Furthermore, hooks are disposed on a side wall of the fastener, hooking grooves are defined on the plugging block, and the hooks are respectively hooked on hooking grooves.

Furthermore, the guitar body comprises an upper box and a lower box. A keyboard fixing piece configured to fix the keyboard is disposed on the upper box.

Furthermore, the keyboard comprises a keyboard box. A clamping groove is defined on a bottom portion of the keyboard box. The keyboard fixing piece is clamped in the clamping groove.

Furthermore, an industrial control board is disposed inside the keyboard box, and keys are disposed on the industrial control board. A buffer rubber pad is disposed between the industrial control board and the keys. An L-shaped light guide strip is disposed on the keys. The L-shaped light guide strip is clamped on the keys through a clamping piece. The first indicator light is connected to the keyboard box through a support. Light sheets are disposed on the light guide strip. When one of the keys is pressed, a corresponding one of the light sheets is controlled to emit light.

Furthermore, the chord board comprises an upper cover board and a fretboard. The upper cover board is mounted on the guitar neck to jointly define a chamber. The second indicator light is mounted in the chamber. The fretboard is disposed on the upper cover board.

Furthermore, light guide columns are embedded in the fretboard. The light guide columns are connected to the second indicator light. Light strips are disposed on the second indicator light, and the light strips are one-to-one corresponding to the light guide columns.

Furthermore, a main control board is disposed in the guitar body. Contact points of the industrial control board are connected to a contact sheet of the main control board, so the main control board is communicated with the industrial control board.

A communication block is disposed in the plugging block. Patches disposed on the fretboard and the second indicator light are connected to an adapter through the communication block. The adapter is disposed at one end of the guitar body close to the chord board. The adapter is connected to the main control board. The main control board is electrically connected to the speaker and the sensor.

The present disclosure not only solves problems of conventional stringless guitars, such as inconvenient portability, poor playing stability, and single function, but also greatly improves the playing experience and creative freedom of the player by introducing functions such as light indication and tone adjustment, thereby providing the player with diverse convenient playing methods.

Specifically, the modular stringless guitar is easy to carry. Due to a detachable structural design between the guitar neck and the guitar body, an assembly and disassembly process of the modular stringless guitar is simplified, making the modular stringless guitar easy to carry and store, and solving the inconvenience of the conventional 1 stringless guitar where the guitar neck and the guitar body are fixedly connected.

The modular stringless guitar is able to be played in a variety of ways. The modular stringless guitar comprises the keyboard and the chord board, so the modular stringless guitar has a variety of playing methods. The modular stringless guitars not only retains the playing characteristics of a classic guitar, but also introduces functions of modern electronic instruments, thereby enriching the playing experience of the player and allowing the player to flexibly choose different suitable playing methods according to different music styles and occasions.

The tuning of the modular stringless guitar is very convenient. The tuning device is disposed on the second end of the guitar neck away from the guitar body, and the tuning device is designed as the rocker, which is convenient for the player to switch the tone during the performance or in an interval, avoiding a problem of accidental touch caused by disposing the tuning device on the guitar body.

Light indication of the modular stringless guitar enhances a performance effect. In the light indication system, the first indicator light and the second indicator light are configured to indicate performance positions on the keyboard and the chord board respectively, so that the player is allowed to more intuitively understand positions corresponding to notes to be played, thereby improving accuracy and efficiency of the performance.

The modular stringless guitar provides playing prompts and feedback. The L-shaped light guide strip and the light sheets are disposed in the keyboard, and the light guide columns and the light strips are disposed in the chord board. Light prompts help the player to play the modular stringless guitar more accurately and enhance the playing experience.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of a modular stringless guitar according to one embodiment of the present disclosure.

FIG. 2 is an exploded schematic diagram of the modular stringless guitar according to one embodiment of the present disclosure.

FIG. 3 is a schematic diagram of a guitar neck according to one embodiment of the present disclosure.

FIG. 4 is an exploded schematic diagram of the modular stringless guitar according to one embodiment of the present disclosure, where the guitar neck is removed.

FIG. 5 is a schematic diagram of a guitar body according to one embodiment of the present disclosure.

FIG. 6 is a schematic diagram of a tuning device according to one embodiment of the present disclosure.

FIG. 7 is a schematic diagram of a keyboard according to one embodiment of the present disclosure.

FIG. 8 is a schematic diagram of the guitar neck and a chord board according to one embodiment of the present disclosure.

In the drawings:

1—keyboard; 11—keyboard box; 111—clamping groove; 12—industrial control board; 13—contact; 14—buffer rubber pad; 15—key; 16—clamping piece; 17—L-shaped light guide strip; 18—support; 19—first indicator light; 2—speaker; 3—guitar body; 31—interface; 32—first mounting space; 33—second mounting space; 34—keyboard fixing piece; 35—contact sheet; 36—adapter; 37—main control board; 38—lower box; 39—upper box; 4—chord board; 41—upper cover board; 42—chamber; 43—second indicator light; 44—fretboard; 45—light guide column; 5—guitarneck; 51—plug-in portion; 52—plugging block; 521—hooking groove; 53—fastener; 531—pressing groove; 532—protruding block; 533—hook; 54—elastic piece; 55—pressing hole; 6—tuning device; 61—rocker; 62—sensor.

### DETAILED DESCRIPTION

Some embodiments of the present disclosure are described in detail below, and optional embodiments of the present disclosure are shown in the accompanying drawings. The accompanying drawings help to well understand the description of the specification, so that a person can intuitively and vividly understand each technical feature and an overall technical solution of the present disclosure. It is noted that the accompanying drawings should not be understood as a limitation to the protection scope of the present disclosure.

The application scenarios of the modular stringless guitar with indicator lights and aspects of contribution to the prior art are described in detail in combination with the accompanying drawings and embodiments.

The present disclosure provides a modular stringless guitar for music lovers. A music lover is able to play the modular stringless guitar having functions of two instruments with two hands, so only one person is able to play two parts, and one person is able to play a piece of music without any partner, or only two or three music lovers are able to complete the performance of a large movement.

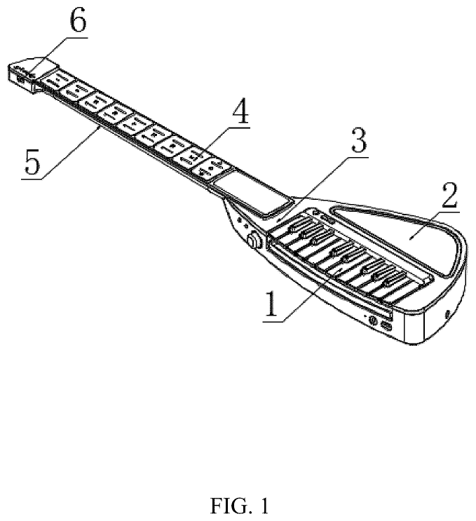

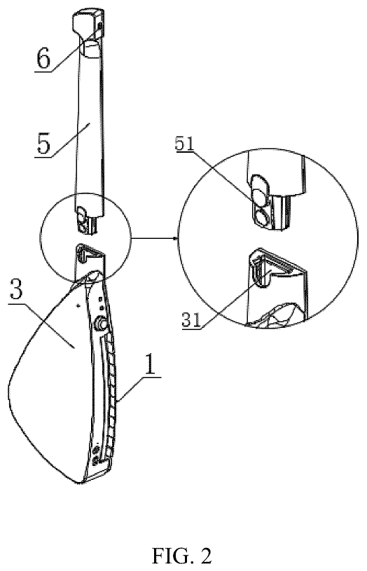

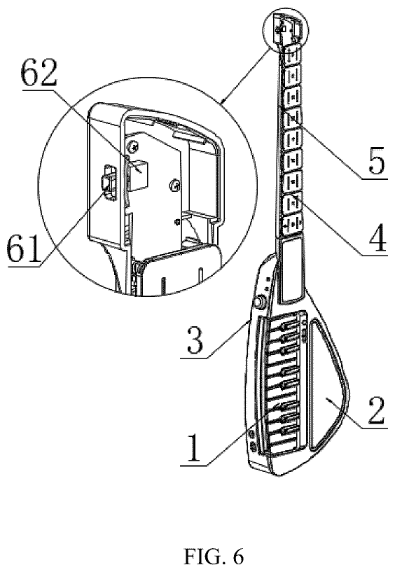

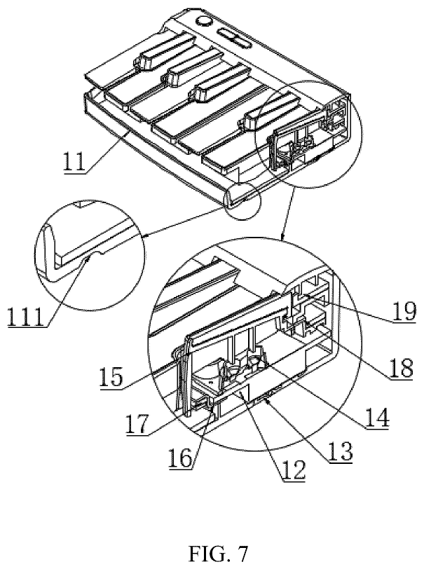

As shown in FIGS. 1-8, the present disclosure provides the modular stringless guitar. The modular stringless guitar comprises a keyboard 1, a speaker 2, a guitar body 3, a chord board 4, a guitar neck 5, a tuning device 6, and a light indication system. The guitar body 3 is a box structure having electronic components disposed therein. The keyboard 1 is disposed in a first mounting space 32 of the guitar body 3. The speaker 2 is mounted in a second mounting space 33 of the guitar body 3. A plug-in portion 51 disposed on a first end of the guitar neck 5 is movably connected to an interface 31 of the guitar body 3. The tuning device 6 is disposed at a second end of the guitar neck 5. The tuning device 6 comprises a rocker 61 and a sensor 62. A first end of the rocker 61 is connected to the sensor 62. A second end of the rocker 61 extends out of a side surface of the guitar neck 5 for a player to operate. The light indication system comprises a first indicator light 19 and a second indicator light 43. The first indicator light 19 is configured to indicate playing positions on the keyboard 1. The second indicator light 43 is configured to indicate playing positions on the chord board 4.

The modular stringless guitar integrates the keyboard 1, the speaker 2, the guitar body 3, the chord board 4, the guitar neck 5, the tuning device 6, and the light indication system. The guitar body 3 has built-in electronic components, and the keyboard 1 and the speaker 2 are respectively placed in different positions of the guitar body 3, making the modular stringless guitar compact and easy to carry. The guitar neck 5 is detachably connected to the guitar body 3 through the plug-in portion 51, which simplifies transportation and storage. The tuning device 6 is disposed at the second end of the guitar neck 5 away from the guitar body 3. The tuning device 6 comprises the rocker 61 and the sensor 62. The player can easily adjust the tone through the rocker 61 without interrupting the performance. The light indication system provides the player with a performance position indication on the keyboard 1 and the chord board 4 through the first indicator light 19 and the second indicator light 43, which enhances the accuracy and efficiency of the performance. A design of the modular stringless guitar not only improves a performance experience of the player, but also improves performance freedom of the player.

As shown in FIGS. 1-3, the plug-in portion 51 comprises a plugging block 52, a fastener 53, and an elastic piece 54. The plugging block 52 is integrally connected to the guitar neck 5. The fastener 53 is hinged to the guitar neck 5. The elastic piece 54 is disposed between the fastener 53 and the plugging block 52. A first end of the fastener 53 is hinged in a pressing hole of the guitar neck 5. A middle portion of the fastener 53 defines a pressing groove. A protruding block is disposed on a second end of the fastener 53. The protruding block is engaged with a groove defined in the interface 31. Furthermore, hooks 533 are disposed on a side wall of the fastener 53, and the hooks 533 respectively hook on hooking grooves 521. The hooking grooves are defined on the plugging block 52.

The plug-in portion 51 makes a connection between the guitar neck 5 and the guitar body 3 stable and also makes the guitar neck 5 and the guitar body 3 easy to disassemble. The plugging block 52 is integrally connected to the guitar neck 5, and the fastener 53 is hinged on the guitar neck 5 and connected to the plugging block 52 through the elastic piece 54. The first end of the fastener 53 is hinged in the pressing hole 55, and the middle portion of the fastener 53 defines the pressing groove 531, which is convenient for the player to operate manually. The protruding block 532 disposed on the second end of the fastener 53 is engaged with the groove in the interface 31 of the guitar body 3 to ensure the connection stability. In addition, the hooks 533 disposed on the side wall of the fastener 53 are matched with the hooking grooves 521 defined on the plugging block 52 to strengthen the connection stability and prevent accidental disengagement. Therefore, the assembly of the guitar neck 5 and the guitar body 3 is simple and quick, while ensuring the reliability and stability during the performance.

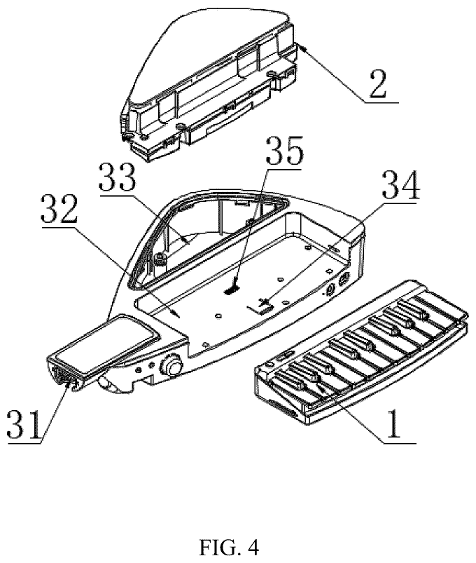

As shown in FIGS. 4-7, the guitar body 3 comprises an upper box 39 and a lower box 38. A keyboard fixing piece 34 configured to fix the keyboard 1 is disposed on the upper box 39. The keyboard 1 comprises a keyboard box 11. A clamping groove 111 is defined on a bottom portion of the keyboard box 11. The keyboard fixing piece 34 is clamped in the clamping groove 111.

The keyboard fixing piece 34 configured to fix the keyboard 1 is disposed on the upper box 39. A main portion of the keyboard 1 is the keyboard box 11, and the clamping groove 111 is defined on the bottom portion of the keyboard box 11. By clamping the keyboard fixing piece 34 in the guitar body 3, the keyboard 1 is stably mounted in the guitar body 3. Therefore, a connection between the keyboard 1 and the guitar body 3 is simplified, and the stability of the keyboard 1 is ensured during performance, avoiding a problem of the keyboard 1 being loose or falling off due to movement or collision during performance, thereby improving the quality of performance. Furthermore, the detachable design increases the portability of the modular stringless guitar, making the modular stringless guitar easy to carry and store.

Furthermore, an industrial control board 12 is disposed inside the keyboard box 11. Keys 15 are disposed on the industrial control board 12. A buffer rubber pad 14 is disposed between the industrial control board 12 and the keys 15. An L-shaped light guide strip 17 is disposed on the keys 15. The L-shaped light guide strip 17 is clamped on the keys 15 through a clamping piece 16. The first indicator light 19 is connected to the keyboard box 11 through a support 18. Light sheets are disposed on the light guide strip 17. When one of the keys 15 is pressed, a corresponding one of the light sheets is controlled to emit light. The industrial control board 12 is disposed inside the keyboard box 11. The keys 15 are disposed on the industrial control board 12. The buffer rubber pad 14 is disposed between the industrial control board 12 and the keys 15., which effectively absorbs the vibration generated during performance and improves the playing feel. The L-shaped light guide strip 17 is disposed on the keys 15. The L-shaped light guide strip 17 is fixed on the keys 15 through the clamping piece 16, so the L-shaped light guide strip 17 is prevented from falling off during the performance. The first indicator light 19 is connected to the keyboard box 11 through the support 18. When one of the keys 15 is pressed, a corresponding one of the light sheets is controlled to emit light. The light sheets on the light guide strip 17 give the player clear position prompts and help the player to find the positions of the notes accurately, thereby improving the accuracy and efficiency of the performance.

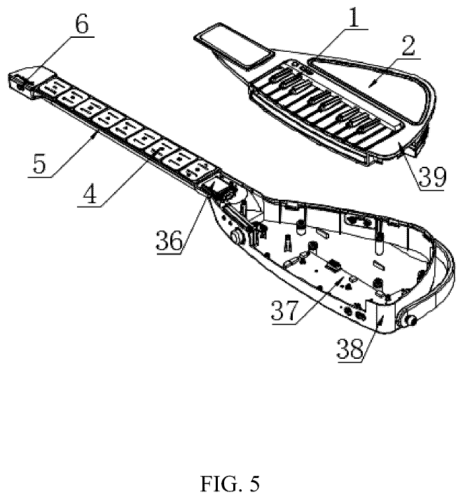

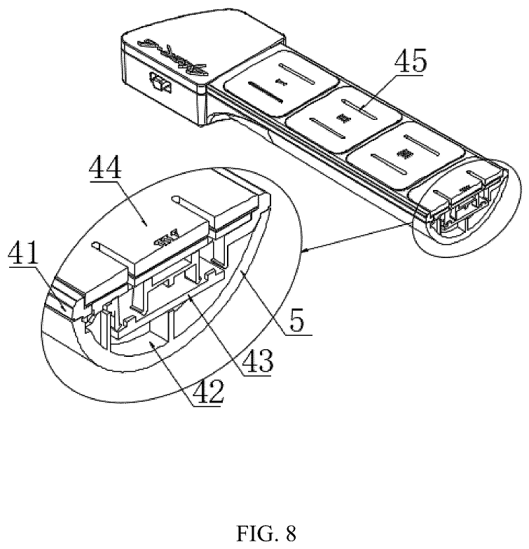

As shown in FIGS. 5 and 8, the chord board 4 comprises an upper cover board 41 and a fretboard 44. The upper cover board 41 is mounted on the guitar neck 5 to jointly define a chamber 42. The second indicator light 43 is mounted in the chamber 42. The fretboard 44 is disposed on the upper cover board 41. Furthermore, light guide columns 45 are embedded in the fretboard 44. The light guide columns 45 are connected to the second indicator light 43. Light strips are disposed on the second indicator light 43, and the light strips are one-to-one corresponding to the light guide columns 45. Such a design allows the light emitted by the second indicator light 43 to be accurately projected to desired positions on the fretboard 44 through the light guide columns 45, providing clear indication to the player and helping the player to perform more accurately.

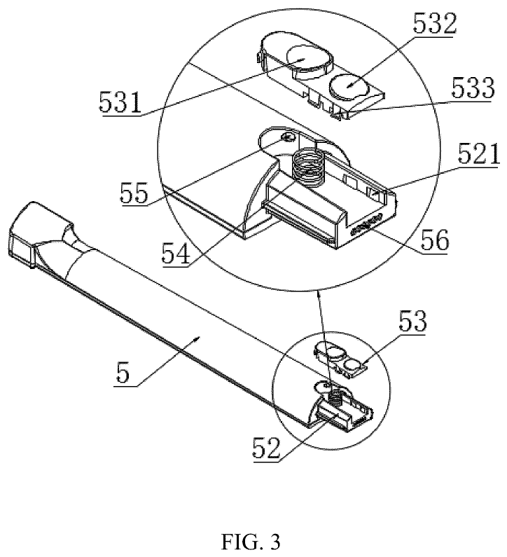

As shown in FIGS. 3-8, a main control board 37 is disposed in the guitar body 3. Contact points 13 of the industrial control board 12 are connected to a contact sheet 35 of the main control board 37, so the main control board 37 is communicated with the industrial control board 12. A communication block 56 is disposed in the plugging block 52. Patches disposed on the fretboard 44 and the second indicator light 43 are connected to an adapter 36 through the communication block 56. The adapter 36 is disposed at one end of the guitar body 3 close to the chord board 4. The adapter 36 is connected to the main control board 37. The main control board 37 is electrically connected to the speaker 2 and the sensor 62.

The main control board 37 mounted inside the guitar body 3 is connected to the contact points 13 of the industrial control board 12 through the contact sheet 35, realizing data communication between the main control board 37 and the industrial control board 12. The communication block 56 in the plugging block 52 is configured to transmit signals of the patches of the fretboard 44 and the second indicator light 43 on the chord board 4 to the adapter 36. The adapter 36 is disposed on one end of the guitar body 3 close to the chord board 4 and is connected to the main control board 37, so that the main control board 37 is able to uniformly manage and process signals from the keyboard 1, the chord board 4, and the tuning device 6, and control the speaker 2 to emit music. The structure of the modular stringless guitar ensures coordinated work between the various components, simplifies an operation process of the player, and improves the overall operation efficiency and performance experience of the modular stringless guitar.

Technical features of the above-mentioned embodiments can be combined arbitrarily. For the sake of brevity, all possible combinations of the technical features in the above-mentioned embodiments are not described. However, as long as there is no contradiction between the combinations of these technical features, the combinations should be considered to be within the scope of the specification.

The above-mentioned embodiments only represent some embodiments of the present disclosure. The descriptions thereof are specific and detailed, but should not be construed as a limitation of the scope of the present disclosure. It should be pointed out that for those of ordinary skill in the art, without departing from the concept of the present disclosure, modifications and improvements can be made. The modifications and the improvements belong to the protection scope of the present disclosure. Therefore, the protection scope of the present disclosure should be subject to the attached claims.

1. A modular stringless guitar, comprising:
a keyboard;
a speaker;
a guitar body;
a chord board;
a guitar neck;
a tuning device; and
a light indication system;
wherein the guitar body is a box structure, the keyboard is disposed in a first mounting space of the guitar body, the speaker is mounted in a second mounting space of the guitar body, and a plug-in portion disposed on a first end of the guitar neck is movably connected to an interface of the guitar body;
wherein the tuning device is disposed at a second end of the guitar neck, the tuning device comprises a rocker and a sensor, a first end of the rocker is connected to the sensor, a second end of the rocker extends out of a side surface of the guitar neck, and the second end of the rocker is configured for a player to operate;
wherein the light indication system comprises a first indicator light and a second indicator light, the first indicator light is configured to indicate playing positions on the keyboard, and the second indicator light is configured to indicate playing positions on the chord board.

2. The modular stringless guitar according to claim 1, wherein the plug-in portion comprises a plugging block, a fastener, and an elastic piece;
wherein the plugging block is integrally connected to the guitar neck, the fastener is hinged to the guitar neck, the elastic piece is disposed between the fastener and the plugging block, a first end of the fastener is hinged in a pressing hole of the guitar neck, a middle portion of the fastener defines a pressing groove; a protruding block is disposed on a second end of the fastener, and the protruding block is engaged with a groove defined in the interface.

3. The modular stringless guitar according to claim 2, wherein hooks are disposed on a side wall of the fastener, the plugging block defines hooking grooves, and the hooks are respectively hooked on the hooking grooves.

4. The modular stringless guitar according to claim 3, wherein the guitar body comprises an upper box and a lower box, and a keyboard fixing piece configured to fix the keyboard is disposed on the upper box.

5. The modular stringless guitar according to claim 4, wherein the keyboard comprises a keyboard box, a clamping groove is defined on a bottom portion of the keyboard box, and the keyboard fixing piece is clamped in the clamping groove.

6. The modular stringless guitar according to claim 5, wherein an industrial control board is disposed inside the keyboard box, keys are disposed on the industrial control board, a buffer rubber pad is disposed between the industrial control board and the keys, an L-shaped light guide strip is disposed on the keys, the L-shaped light guide strip is clamped on the keys through a clamping piece, the first indicator light is connected to the keyboard box through a support, light sheets are disposed on the light guide strip, and when one of the keys is pressed, a corresponding one of the light sheets is controlled to emit light.

7. The modular stringless guitar according to claim 6, wherein the chord board comprises an upper cover board and a fretboard, the upper cover board is mounted on the guitar neck to jointly define a chamber, the second indicator light is mounted in the chamber, and the fretboard is disposed on the upper cover board.

8. The modular stringless guitar according to claim 7, wherein light guide columns are embedded in the fretboard, the light guide columns are connected to the second indicator light, light strips are disposed on the second indicator light, and the light strips are one-to-one corresponding to the light guide columns.

9. The modular stringless guitar according to claim 8, wherein a main control board is disposed in the guitar body, contact points of the industrial control board are connected to a contact sheet of the main control board, so the main control board is communicated with the industrial control board;
wherein a communication block is disposed in the plugging block, patches disposed on the fretboard and the second indicator light are connected to an adapter through the communication block, the adapter is disposed at one end of the guitar body close to the chord board, the adapter is connected to the main control board, and the main control board is electrically connected to the speaker and the sensor.
